(19) United States
(12) Patent Application Publication
(10) Pub. No.: US 2011/0153365 A1
(43) Pub. Date: Jun. 23, 2011

(54) SYSTEM AND METHOD OF MANAGING AND DOCUMENTING LACTATION DATA

(75) Inventors: Paula Meier, Oak Park, IL (US); Janet Engstrom, Chicago, IL (US); Briana J. Jegier, Chicago, IL (US)

(73) Assignee: RUSH UNIVERSITY MEDICAL CENTER, Chicago, IL (US)

(21) Appl. No.: 12/993,328

(22) PCT Filed: May 19, 2009
(86) PCT No.: PCT/US2009/044429

§ 371 Date: Mar. 10, 2011

Related U.S. Application Data
(60) Provisional application No. 61/054,707, filed on May 20, 2008.

(51) Int. Cl. G06Q 50/00

(52) U.S. Cl. 705/3

(57) ABSTRACT

A system and method of managing and documenting lactation data includes inputting patient lactation data, retrieving, editing, creating, or updating a database to include the patient lactation data in real time, and storing the patient lactation data in a database which can be centrally located to facilitate integration with other medical records.

### CROSS REFERENCE TO RELATED APPLICATIONS

The present application claims priority to U.S. provisional application Ser. No. 61/054,707, filed on May 20, 2008.

### BACKGROUND

A system and method are described for managing data, for example, lactation data.

Medical professionals, generally in a Neonatal Intensive Care Unit (NICU), document lactation data relating to lactation interventions. Currently, methods of documenting lactation interventions by lactation professionals undesirably require large equipment in a congested NICU; or resort to inefficient and cumbersome paper-and-pencil documentation. Further, data such as patient medical records are generally stored in different locations than lactation data, decreasing analysis efficiency by not readily incorporating all relevant information.

### SUMMARY

A system and method of managing lactation data has improved efficiency, decreased spatial needs, and decreased time between data entry and availability for analysis and integration. Lactation data is stored for ease of retrieval, analysis, and updating.

A system and method of managing and documenting lactation data is provided. The method includes inputting patient lactation data, retrieving, editing, creating, or updating a database to include the patient lactation data in real time, and storing the patient lactation data in a database that is centrally located to facilitate integration with other medical records.

One aspect of the present disclosure includes a data management system for recording and monitoring lactation data. The data management system of the present disclosure includes a computer system. The computer system includes a server having a computer readable program code, an application module, and a database module configured to contain one or more bits of information. The data management system of the present disclosure also includes a user interface remote from the computer system and a communications link connecting the computer system and the user interface. The data management system is configured for simultaneous operation by one or more users. In particular, the data management system is configured to allow the one or more users to remotely access the application module of the computer system through the user interface thereby allowing the one or more users to input and retrieve the patient data in real time.

Further, the computer readable program code is configured to be executed to implement a method for managing and documenting lactation data. The method includes the following steps: prompting the one or more users for login information and to receive the login information from the one or more users; providing a user interface configured to allow input, editing, viewing, organizing and retrieval of patient data in real time by one or more users; prompting the one or more users for patient data; receiving patient data input from the one or more users; communicating the patient data to a database; and storing the patient data in the database. Additionally, the data management system is configured to generate documents from the information contained in the database module.

Another aspect of the present disclosure includes a computer program product. The computer program product includes a computer usable medium having a computer readable program code disposed thereon. The computer readable program code is configured to be executed to implement method for managing and documenting lactation data. The method comprising the following steps: providing a user interface configured to allow input, editing, viewing, organizing and retrieval of patient data in real time by one or more users; receiving patient data input from the one or more users; communicating the patient data to a database; and storing the patient data in the database.

The computer program product may include computer readable program code configured to be executed to prompt the one or more users for login information and to receive the login information from the one or more users. The computer readable program code may also be configured to be executed to prompt the one or more users for patient data that includes personal information. Such personal information may include one or more attributes such as: first name, last name, hospital, maternal medical record, race, parity, birth date, home address, state, postal code, home telephone number, cellular telephone number, alternative telephone number, email address, education level, eligibility for government assistance, registration status for government assistance, total number of adults living in household, total number of children living in household, household income amount, occupation, date of return to work, gravida, para, T, and P.

Further, the computer program product may be configured to be executed to prompt the one or more users for patient data including one or more lactation events associated with a particular patient, such as: initial lactation risk assessment; selection and instructions for use of an electric breast pump; correctly fitting breast pump equipment to an individual; review of lactogenesis, maternal medications, and dietary considerations with respect to producing an adequate volume of milk; instructions for use of a maternal milk volume record; instructions for proper collection, labeling, storage, and transport of expressed human milk; daily monitoring of maternal milk volume, creamatocrit measures, and number of times the breast pump is used; mother's use, dosing, and duration of prescription and non-prescription galactagogues; daily monitoring of an infant's total intake of human milk volume and non-human milk volume; documentation of attendance at Mothers' Milk Club meetings; documentation of assistance with at-breast feeding, including volume of milk consumed by an infant; preparation for feeding at breast and continued milk expression during a post-discharge period; and documentation of interactions with a mother; documentation of interactions with other health care providers.

### BRIEF DESCRIPTION OF THE DRAWINGS

FIG. 1 is a schematic diagram of the system for managing and documenting lactation data of the present disclosure;

FIG. 2 is an exemplary screenshot showing a login module having an unassigned password of the system of managing and documenting lactation data;

FIG. 3 is an exemplary screenshot showing the login module having an unassigned password including exemplary user input;

FIG. 4 is an exemplary screenshot showing the login module having an unassigned password including exemplary user input and a password window;

FIG. 5 is an exemplary screenshot showing the login module having an assigned password including exemplary user input;

FIGS. 6-8 are exemplary screenshots showing a hypothetical patient record module of the system of managing and documenting lactation data including exemplary patient data;

FIG. 9 is an exemplary screenshot showing an add new/edit main record module of the system of managing and documenting lactation data;

FIGS. 10-16 are exemplary screenshots showing the add new/edit main record module of the system of managing and documenting lactation data including exemplary data.

### DETAILED DESCRIPTION

While the present disclosure may be susceptible to embodiment in different forms, there are shown in the drawings, and herein will be described in detail, embodiments with the understanding that the present description is to be considered an exemplification of the principles of the disclosure and is not intended to limit the disclosure to the details of construction and the arrangements of components set forth in the following description or illustrated in the drawings.

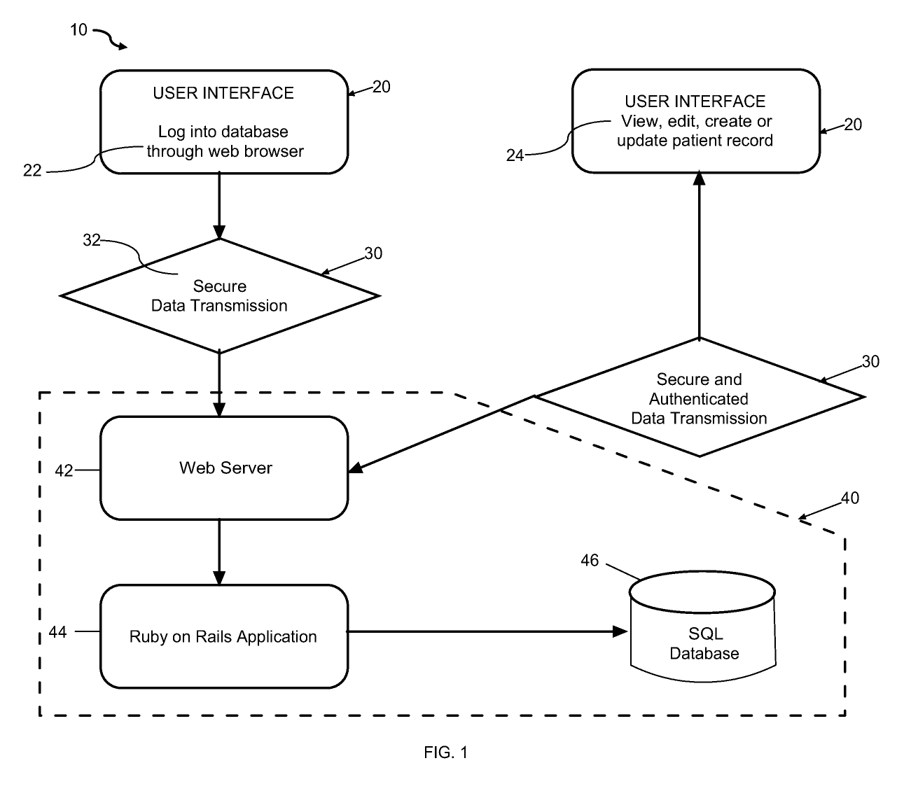

Referring now to FIG. 1, a block diagram is shown of a system of managing and documenting lactation data 10, hereinafter system 10. The system 10 includes one or more user interfaces 20 and a lactation computer system 40. One or more user interfaces 20 are connected with lactation computer system 40 by one or more communication links 30. Although only two user interfaces 20 and two communication links 30 are shown in FIG. 1, those skilled in the art will appreciate that as many user interfaces and communication links may be connected with system 10 in order to give the appropriate users access to a resulting network.

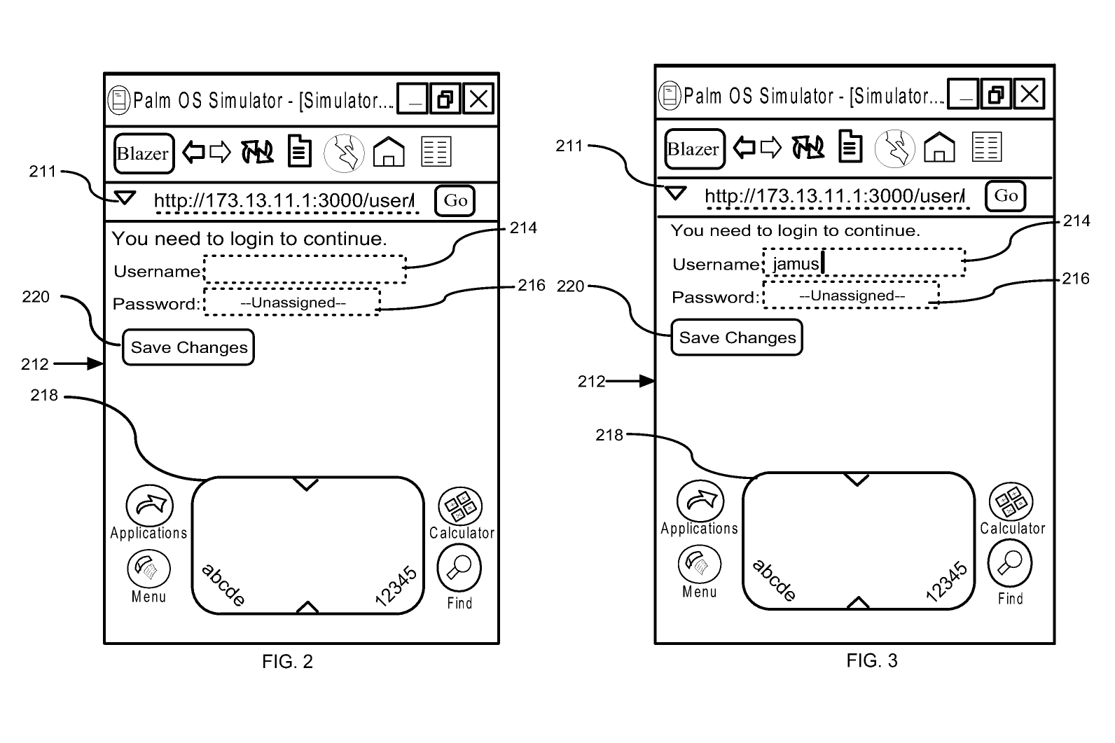

The lactation computer system 40 includes a server 42 capable of access to HTML documents, software application module 44, and one or more database modules 46. The application module 44 includes computer readable program code configured to execute a method for managing lactation data. It is also within the scope of the present disclosure that the computer readable program code be embodied on a separate computer usable medium, separate from the server 42 and application module 44. The application module 44 contains one or more software applications including framework applications such as Ruby within Ruby on Rails™ framework. The database module 46 may include, for example, a MySQL, SQLite, or SQL database. The database module 46 may be written specifically for web access point login and include encryption of personal identifiers and password safeguards. The application module 44 and database module 46 may be used with Palm OS®, Linux®, Windows®, Mac®, and any other operating system. The software module 44 and database module 46 may include pages, such as, screenshots shown in FIGS. 2 through 16 for increased clarity and increased speed in data viewing, entry, and editing on a handheld device in real time. The system 10 enables seamless practice and documentation of practice interventions for lactation professionals whose work is concentrated in the NICU.

The users may access the server 42 through a web browser on one or more user interfaces 20. One or more interfaces 20 may be hand-held devices with web access and interface. The one or more user interfaces 20 are described herein by way of example as control processing units. Of course, it is contemplated by the present disclosure for one or more user interfaces 20 to include any programmable circuit, such as, but not limited to, computers, processors, microcontrollers, microcomputers, programmable logic controllers, application specific integrated circuits, and other programmable circuits. It is further contemplated by the present disclosure that the user interface is any number of control devices providing various types of control, e.g., centralized, distributed, redundant and/or remote control. Each of the web browsers are connected to server 42 and other user interfaces 20 via one or more communication links 30. The operating details of one or more communication links, such as the internet, the use of HTML documents, and the software and formats used in client-server relationships, are known in the art, and therefore will not be discussed herein.

The system 10 enters, organizes, stores, edits, and views lactation data in real-time and is usable by one or more users simultaneously. The one or more users may include all lactation professionals. The lactation professionals may practice in Level II and Level III maternity/NICU settings. For example, Level III NICU care provides the highest level of care to infants and provides access to other medical specialists, such as cardiologists and infectious disease physicians. Level II NICU care provides intermediate infant intensive care, but does not treat ventilator-dependant infants or those infants requiring pediatric specialist care.

Lactation data includes data, such as, practice and documentation of practice interventions for lactation professionals. Real-time availability provides access to entered or updated data substantially upon entry of the data. The system 10 maximizes data entry efficiency and may reflect lactation professional standards of practice. Such standards of practice may serve as a means of coordinating and documenting lactation care for all professionals working with lactation in the NICU, including nurses, lactation consultants, dieticians, and physicians. The system of the present disclosure, therefore, may operationalize standards of lactation practice across a multi-disciplinary team.

The system 10 may include a first user inputting login information through a first user interface 22. The login information is communicated by a first data link 32 of one or more communication links 30. Communication by one or more communication links 30 may be communicated by a secure and authenticated data transmission. The first data link 32 communicates the login information to server 42. A second user inputs patient lactation data to view, edit, create or update a patient record in a second user interface 24. Although first user interface 22 and second user interface 24 are shown as different user interfaces in FIG. 1, any number of users may input login information and/or patient lactation data in any number of user interfaces. The server 42 may communicate via one or more communication links 30 the patient lactation data entered by the user. The software contained in the application module 44 retrieves, edits, creates, or updates database module 46 to include the login information or patient lactation data inputted by the first user and/or second user in real time. The database module 46 stores the login information and/or the patient lactation information. The patient lactation data and the login information may be encrypted during entry upload, entry download, and when stored. The communication between one or more interfaces 20 and server 40 allows each user, for example, a lactation professional, to access another user's data facilitating real time updating and recording of data. The data stored in the database module may also include medical records. The medical records provide access to relevant clinical lactation data.

FIGS. 2 through 4 are exemplary screenshots showing a login module 212 of system 10 using a web browser of Palm OS Simulator. The lactation computer system 40 may direct and display login module 212 by an http address 211. The user inputs login information through one or more user interfaces. The login information may include a username and password.

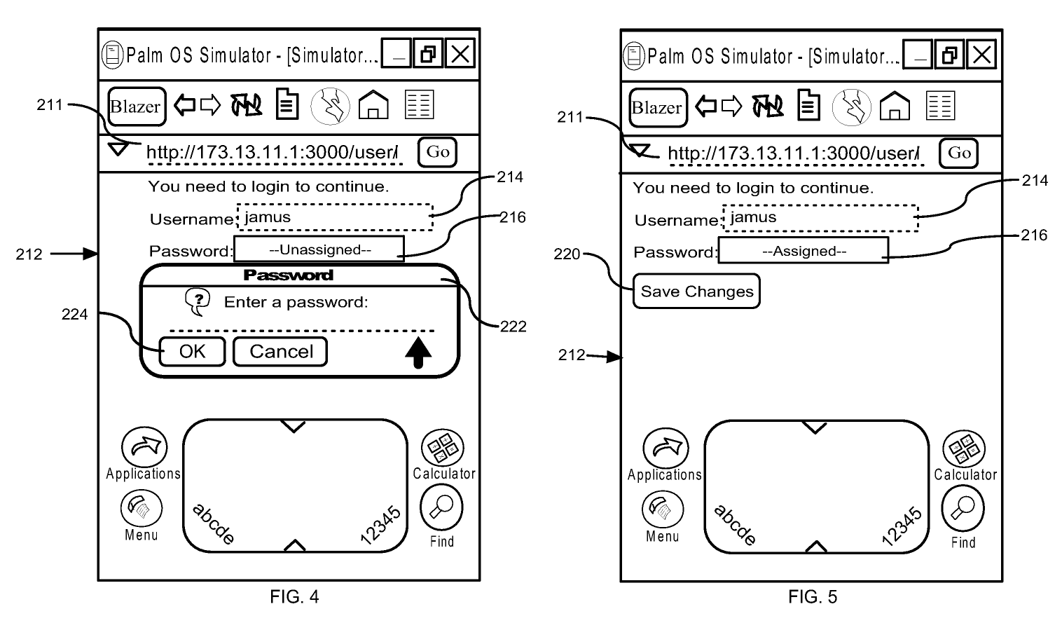

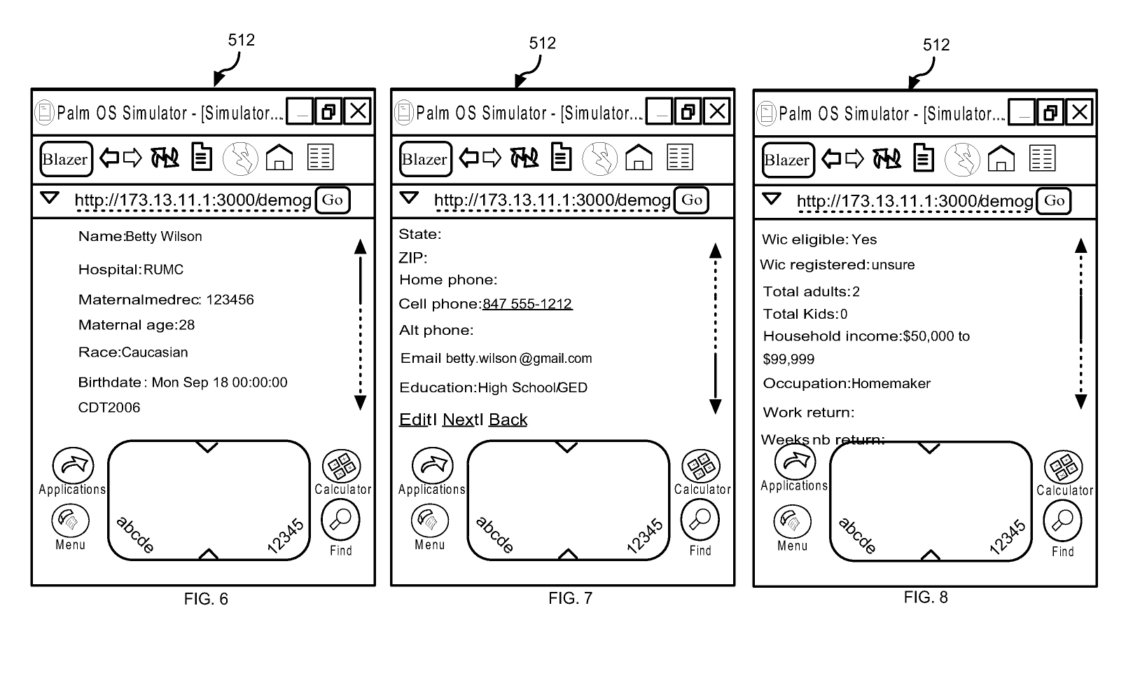

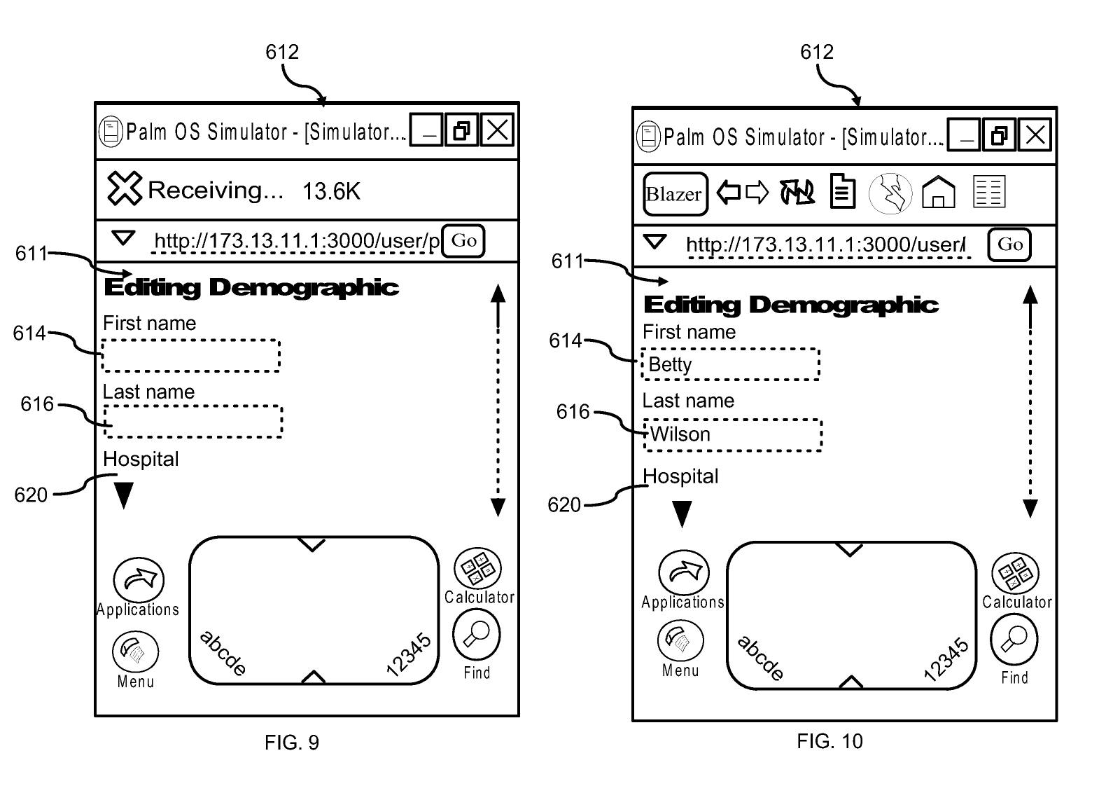

The login module 212 may include a Username cell 214 and a Password cell 216. The user may input a username, for example, “jamus,” in Username cell 214 through the user interface, such as, for example, by a stylus in a graffiti writing area 218 of a Palm OS Simulator, keyboard, or any inputting user interface device. The Password cell 216 indicates that a password is unassigned to the username in Username cell 214, as shown in FIG. 3. The user may input a password by selecting Password cell 216 displaying a password window 222, as shown in FIG. 4. The user may enter a password in password window 222 and select an OK button 224 to assign the password to the username entered in login module 212. Upon assigning a password in password window 222, Password cell 216 indicates that the password is assigned, as shown in FIG. 5. The user may select a Save changes button 220 to communicate and store the username and the password inputted into login module 212 on the database.

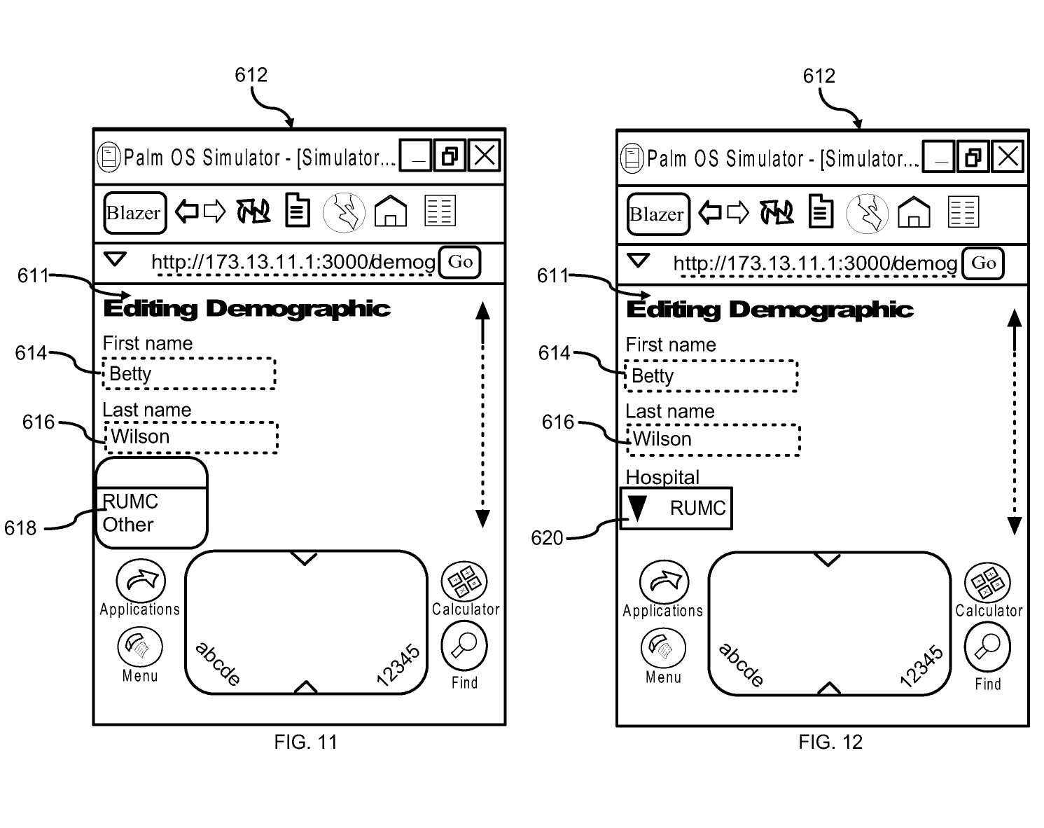

The user may input patient lactation data to view a patient record in system 10. The lactation computer system 40 communicates one or more communication links 30 to retrieve and display the patient record. FIGS. 6 through 8 are exemplary screenshots showing a patient record module 512 of system 10. The patient record module 512 displays information related to a patient, such as, for example, first name, last name, hospital, maternal medical record, “maternal medrec” shown in FIG. 6, maternal age, race, parity, birth date, home address, state, postal code, home telephone number, cellular telephone number, alternative telephone number, email address, level of education, eligibility for government benefits, registration status for government benefits, total number of adults in household, total number of children in household, household income amount, occupation, anticipated date of work return, or any other information related to the patient.

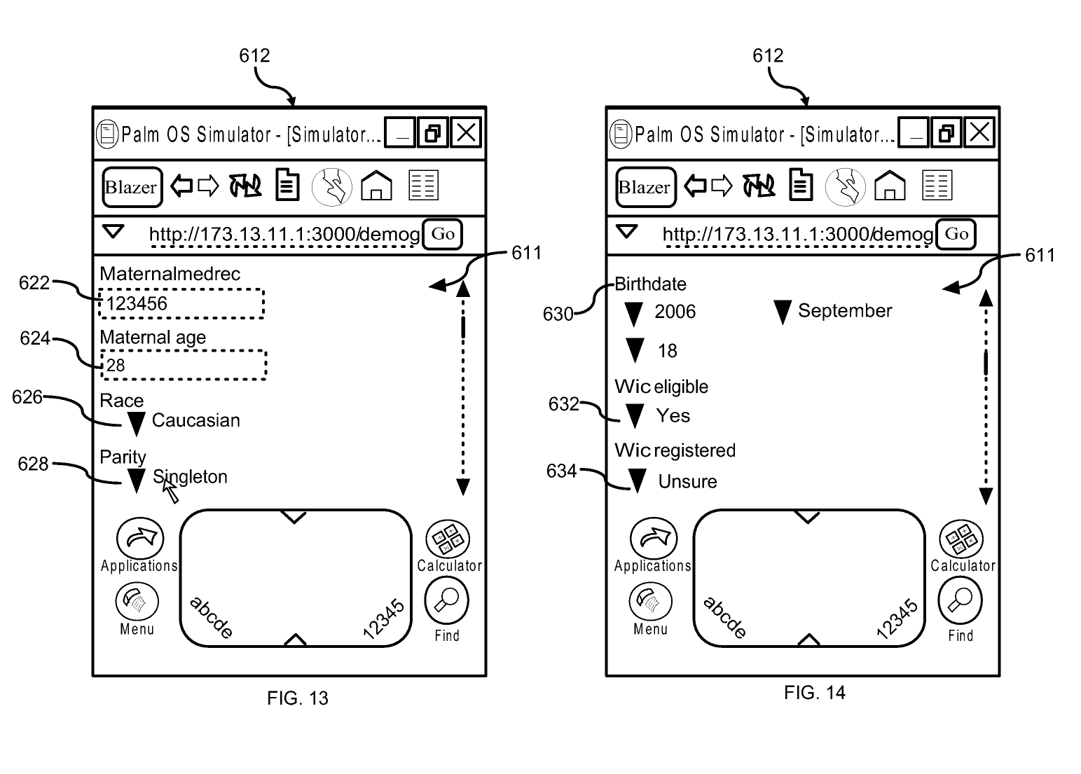

The user may input patient lactation data to add or edit a patient record in system 10. FIGS. 9 through 16 are exemplary screenshots showing an add new/edit main record module 612 of system 10. The add new/edit main record module 612 adds or edits information related to a patient, such as, a first name, last name, hospital, maternal medical record, maternal age, race, parity, birth date, state, postal code, home phone, cell phone, alternative phone, email address, education, WIC eligible, WIC registered, total adults, total kids, household income, occupation, work return, Gravida, Para, T, P, or any other information related to the patient. Gravida is the total number of pregnancies a woman has had. Para is the number of births of viable children a woman has had. T is the number of term infants after thirty-seven weeks gestation a woman has had. P is number of premature births a woman has had between twenty to thirty-seven weeks gestation.

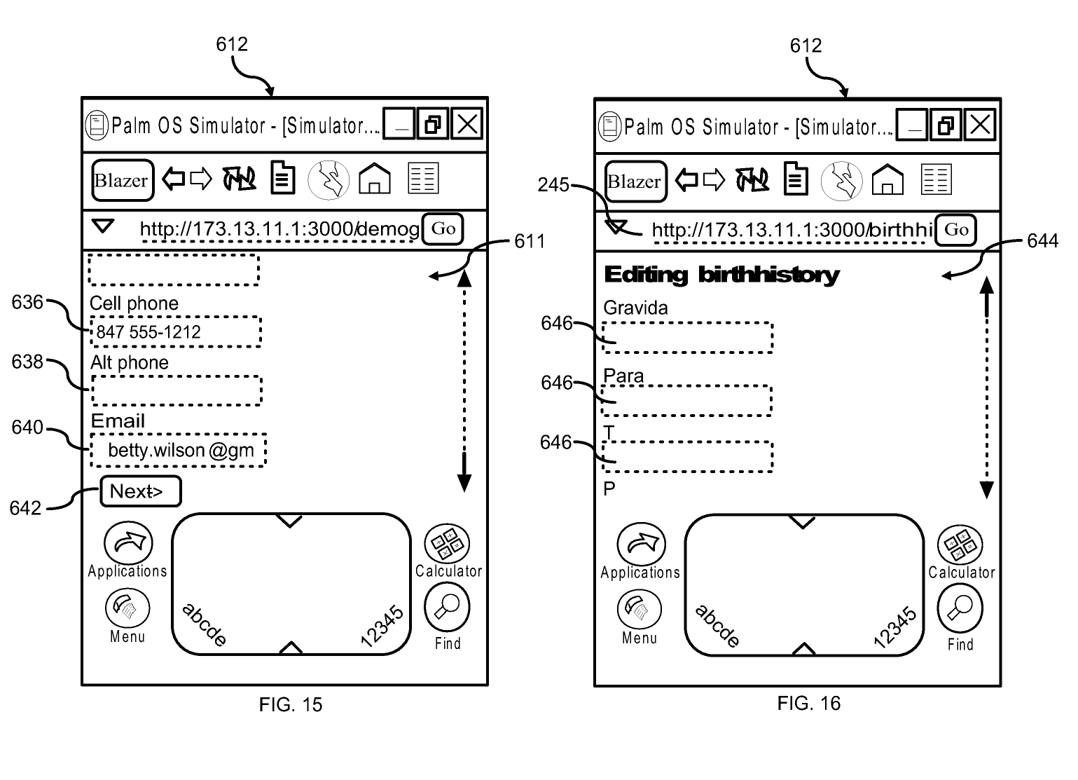

FIGS. 9 through 16 show an example of adding a new patient. FIG. 9 displays an Editing demographic page 611 that includes a first name cell 614 and a last name cell 616. The user may input the patient's first name in first name cell 614 and last name in last name cell 616 by the user interface, such as, the web browser of Palm OS Simulator, as shown in FIG. 10, for example, by a stylus in a graffiti writing area, keyboard, or any inputting interface device. The user may input a patient's hospital in a Hospital cell 620 by selecting a hospital listed in a Hospital dropdown menu 618, as shown in FIG. 11. Upon selection of one of the hospitals in hospitals listed in Hospital dropdown menu 618, a selected hospital appears in Hospital cell 620, as shown in FIG. 12. The user may input the patient's maternal medical record number in a Maternal medrec cell 622 and age in a Maternal age cell 624 by the user interface. The user may input a patient's race in a race cell 626 and a patient's parity in a parity cell 628 by selecting data listed in one or more drop down menus, as shown in FIG. 13. The user may input a patient's birth date in one or more Birthdate cells 630, if a patient is WIC eligible in a WIC eligible cell 632, and if a patient is WIC registered in a WIC registered cell 634, by selecting data listed in one or more drop down menus, as shown in FIG. 14. WIC is a grant program administered by the United States federal government for providing supplemental nutritious foods, nutrition education, and counseling at WIC clinics and provides screening and referrals to other health, welfare and social services to a low-income and nutritionally at risk population. The user may input a patient's cell phone number in a Cell phone cell 636, an alternative patient phone number in an Alt phone cell 638, and a patient's email address in an email cell 640 by the user interface, as shown in FIG. 15.

The user may input patient lactation data with a user interface into a single page of add new/edit main record module 612 such that the user may scroll the page down through the user interface as shown in FIGS. 13 through 15. The user may input information with the user interface on a second page of add new/edit main record module 612 by the user selecting a Next button 642 directing the web browser to a second page 644 having another http address 245 of add new/edit main record module 612. The second page 644 may input or edit birth history of the patient, such as, Gravida, Para, T, and P, as shown in FIG. 16. The user may input patient lactation data in cells 646 for Gravida or total number of pregnancies a woman has had, regardless of whether they were carried to term, Para or number of births of viable children, T or number of term infants after thirty-seven weeks gestation, and P or number of premature births between twenty to thirty-seven weeks gestation, and any further data relating to birth history.

The system 10 may further include pages that have checklists, clocks, and calendars to record lactation data. The checklists, clocks, and calendars reduce time required to input information over prior art methods of data entry. Also, system 10 may also include a data connection for interfacing with external devices or computer software. For example, system 10 may be configured to connect with a thermometer, creamatocrit machine, weigh scale, or other device. Also, the system may upload or download data to a database or other software application.

Record module 612 may also include a time stamp module. Such a time stamp module may be used to record the start and finish time of a patient visit. A time stamp module may also be used to record other time periods of interest, such as length of time a breast pump is used, either per milk expression session, or per day.

Record module 612 may also contain one or more templates containing check boxes for entering data. For example, check boxes may be used to record medications, dose, and indications. Check boxes may also be used to indicate the presence or absence of conditions that may compromise lactation or may alert the practitioner to the need for additional intervention. Check boxes may be used to document a variety of data and avoids interpretation errors.

The system 10 may generate computerized database documents for lactation practice. The computerized database documents may generate billing and other cost/charge related reports or analysis. The reports or analysis assist in research. For example, system 10 may interface with hospital or other external billing systems to provide data such that services and supplies can be appropriately charged to the patient's account.

The user interface may be a hand-held device, for example, a hand-held device marketed under the trademark Palm®. Lactation professionals collect data with custom designed handheld computers in the NICU. The hand-held device provides the benefit of minimum size in an environment, such as the NICU, and greater efficiency relative to paper-and-pencil documentation. The hand-held device communicating and accessing the database allows a first lactation professional to input data with a first hand-held device and another lactation to access the data with a second hand-held device for real time updating and recording of lactation data, such as, lactation interventions.

Lactation interventions in the NICU may include but are not limited to the following activities: initial lactation risk assessment; selection and instructions for use of the electric breast pump; correctly fitting the breast pump equipment to the individual mother; review of the processes of lactogenesis, maternal medications, and dietary considerations with respect to producing an adequate volume of milk; instructions for use of the maternal milk volume record; instructions for proper collection, labeling, storage, and transport of expressed human milk; daily monitoring of maternal milk volume, creamatocrit measures, and number of times the breast pump is used; mother's use, dosing, and duration of prescription and non-prescription galactagogues; daily monitoring of the infant's total human milk (mLs) and non-human milk (mLs) of intake; documentation of attendance at Mothers' Milk Club meetings; documentation of assistance with at-breast feeding, including mLs of milk consumed by the infant (test-weights); preparation for feeding at breast and/or continued milk expression in the post-NICU discharge period; documentation of interactions with the mother, including whether these are initiated by maternal request (e.g., question or concern), or referral (e.g., physician or nurse); or due to a user-generated concern such as the need to increase the caloric density in the mother's milk; 14) documentation of interactions with other health care providers (e.g., private pediatrician, mother's obstetrician, social worker) in order to address the mother's concerns, questions, or problems. The hand-held device may also download information into a patient or infant's medical record so that all NICU health care providers have access to relevant clinical lactation data.

An example of lactation intervention may include the following activities and events:

A mother is visited by the lactation specialist. This may occur prior to the infant's birth (antenatal hospitalization of the mother) or following the birth of the infant.

The lactation specialist discusses the provision of human milk with the mother and documents mother's initial intent (e.g., formula-feed or human milk-feed) and whether she has changed her mind (usually from formula to human milk) after speaking with a care provider. Several check boxes are marked to document mother's initial intent, current intent, plans at infant discharge, sources of support for her decision, and any concerns (such as a father not agreeing with the decision, or a grandmother's concerns about poor maternal diet) the mother may have that affect the decision to provide milk. A check box may also be used to select and document an action plan.

The lactation specialist determines that mother intends to provide milk and completes the following interventions at the time of the initial conversation with the mother (preliminary data indicates that this takes about 80 minutes): A) Lactation Risk Assessment (check-box and drop-down list); B) Teaches mother the principles of lactogenesis, including expected milk volume targets over the first two weeks post-birth; C) Teaches the mother that hormonal birth control methods administered early in the post-birth period will likely interfere with successful lactation; D) Instructs and observes mother's use of the electric breast pump; E) Ensures that the breast pump collecting equipment is functioning appropriately and sized correctly for the individual mother; F) Reviews with the mother a schedule for use of the breast pump in the home and hospital; G) Reviews correct collection, labeling, storage and transport of milk, using English and Spanish tear sheets to reinforce teaching; H) Instructs the mother in the proper cleaning of breast pump equipment; I) Informs the mother about social support services such as Mothers' Milk Club luncheons and accessing Mothers' Milk Club complimentary taxi service to attend the luncheons; J) Provides the mother with phone numbers for 24-hour assistance with lactation questions; K) Provides the mother with milk volume records and demonstrates their use; L) Provides the mother with written pamphlets and tear sheets as appropriate.

After the initial visit the mother is seen or contacted by telephone at least every 48 hours with the following goals (all of which have specific action components which are documented and coordinated via the system 10 of the present disclosure): A) Ensuring that maternal milk volume is adequate, using maternal milk volume records and monitoring of milk storage containers filled by the mothers; B) Trouble-shooting milk volume problems through review of maternal milk volume records, observation of pumping equipment and technique, and assessing common causative factors such as maternal anxiety and insomnia; C) Diagnosing and managing maternal milk volume problems using nonpharmacologic and pharmacologic (e.g., galactagogues) therapies; D) Reviewing of any other concerns for which the lactation specialist may assist, such as providing a letter for insurance reimbursement of breast pump rental or a letter to the mother's employer clarifying her need to use the breast pump in the workplace.

Further activities may include monitoring and documenting an infant's tolerance and growth on human milk feedings, including the following: A) Documenting volume (mLs) of human milk and non-human milk (formula; mLs) for each feeding each day for the infant; B) Documentation of infant weight each day, and other anthropometric measures on a weekly basis; C) Documenting all major infant morbidities (e.g., infection, necrotizing enterocolitis) for which human milk has been shown to be protective; D) Trouble-shooting slow weight gain in human milk-fed infants, including the use of the creamatocrit to measure caloric density in the milk, the actual creamatocrit values, and the milk expression plan to achieve the desired caloric density in the milk.

Documenting any maternal medications introduced after the time of birth, and the recommendation for the continued use of human milk (check box primarily).

Monitoring and documenting assistance with at-breast feedings, including: A) Initial “tasting” of milk prior to the time infant is actually ready to “drink” milk at the breast; B) Positioning techniques used to assist the mother; C) The use of breastfeeding aids such as the nipple shield and BabyWeigh™ scale (to measure milk intake during breast feeding), including charges for this equipment; D) Milk intake patterns each day to trend over time and prepare for hospital discharge.

Prepare mother and infant for breastfeeding in the post-NICU discharge period, including: A) Measuring milk intake during breastfeeding to determine infant's intake patterns; B) Discussing minimum daily intake recommendations with the infant's neonatologist, and coordinating these plans with the family; C) Identifying the mother's source of follow-up for lactation in the community, and making referrals as needed; D) Organizing rental of the BabyWeigh™ scale if needed by the family; E) Organizing third party reimbursement for the scale rental.

Monitoring lactation during the post-NICU discharge period until mother has achieved her primary breastfeeding goal (e.g., exclusive at-breast feeding, partial breast and partial bottle feeding of human milk, etc.), including: A) Maintaining regular telephone contact, commencing within 48 hours after hospital discharge; B) Determining whether mother needs a home visit from a lactation specialist in the community or from the health care team; C) Determining whether mother should be seen in the lactation clinic; D) If infant is seen in the lactation clinic, the interventions would include measuring milk intake with test-weights and measuring caloric content in mothers' milk with the creamatocrit.

The components of the present disclosure are described herein in terms of functional block components, flow charts and various processing steps. As such, it should be appreciated that such functional blocks may be realized by any number of hardware and/or software components configured to perform the specified functions. For example, the present disclosure may employ various integrated circuit components, e.g., memory elements, processing elements, logic elements, look-up tables, and the like, which may carry out a variety of functions under the control of one or more microprocessors or other control devices.

Similarly, the software elements of the present disclosure may be implemented with any programming or scripting language such as C, SQL, MySQL, SQLite, C++, Java, COBOL, assembler, PERL, or the like, with the various algorithms being implemented with any combination of data structures, objects, processes, routines or other programming elements. Further, it should be noted that the present disclosure may employ any number of conventional techniques for data transmission, signaling, data processing, network control, and the like as well as those yet to be conceived. While this disclosure has been described as having exemplary embodiments, this application is intended to cover any variations, uses, or adaptations using the general principles set forth herein. It is envisioned that those skilled in the art may devise various modifications and equivalents without departing from the spirit and scope of the disclosure as recited in the following claims. Further, this application is intended to cover such departures from the present disclosure as come within the known or customary practice within the art to which it pertains.

What is claimed is:

1. A data management system for recording and monitoring patient data, comprising:
a computer system comprising
a server,
an application module, and
a database module configured to contain one or more bits of information;
a user interface; and
a communications link connecting the computer system and the user interface,
wherein the data management system is configured for simultaneous operation by one or more users, and wherein the data management system is configured to allow the one or more users to remotely access the application module of the computer system through the user interface, thereby allowing the one or more users to input and retrieve the patient data in real time, and wherein the data management system is configured to generate documents from the information contained in the database module.

2. The data management system of claim 1 wherein the application module further comprises:
a login module configured to allow access to the data management system after receiving a username and password from each of the one or more users;
a main record module configured to allow the one or more users to add a new record to the database module and to edit an existing record contained within the database module; and
a patient record module configured to allow the one or more users to input one or more bits of patient-specific information to the database module.

3. The data management system of claim 2 wherein the main record module further comprises a time stamp module, wherein the time stamp module is configured to record a start time and a finish time of a patient visit.

4. The data management system of claim 2 wherein the main record module further comprises one or more predefined templates configured for entry of data.

5. The data management system of claim 2 wherein the patient record module is configured to receive lactation intervention data.

6. The data management system of claim 5 wherein the patient record module is configured to receive patient follow up data.

7. The data management system of claim 6 wherein the patient record module is configured to receive data documenting assistance with at-breast feedings.

8. The data management system of claim 7 wherein the patient record module is configured to allow monitoring of lactation data.

9. The data management system of claim 2 wherein the data management system is configured to provide data to one or more other external computer systems for creation of one or more reports.

10. The data management system of claim 9 wherein the one or more reports comprise one or more of the following group consisting of: a billing report, a cost report, a charge report, and an analysis report.

11. A computer program product comprising:
a computer usable medium having a computer readable program code disposed thereon;
the computer readable program code configured to be executed to implement method for managing and documenting lactation data, the method comprising the following steps:
providing a user interface configured to allow input, editing, viewing, organizing and retrieval of patient data in real time by one or more users;
receiving patient data input from the one or more users;
communicating the patient data to a database and
storing the patient data in the database.

12. The computer program product of claim 11 wherein the computer readable program code is configured to be executed to prompt the one or more users for login information and to receive the login information from the one or more users.

13. The computer program product of claim 12 wherein the computer readable program code is configured to be executed to prompt the one or more users for patient data comprising personal information.

14. The computer program product of claim 13 wherein the personal information comprises one or more attributes selected from the group consisting of: first name, last name, hospital, maternal medical record, race, parity, birth date, home address, state, postal code, home telephone number, cellular telephone number, alternative telephone number, email address, education level, eligibility for government assistance, registration status for government assistance, total number of adults living in household, total number of children living in household, household income amount, occupation, date of return to work, gravida, para, T, and P.

15. The computer program product of claim 14 wherein the readable program code is configured to be executed to prompt the one or users for patient data comprising one or more lactation events associated with a particular patient.

16. The computer program product of claim 15 wherein the one or more lactation events comprises one or more events selected from the group consisting of: initial lactation risk assessment; selection and instructions for use of an electric breast pump; correctly fitting breast pump equipment to an individual; review of lactogenesis, maternal medications, and dietary considerations with respect to producing an adequate volume of milk; instructions for use of a maternal milk volume record; instructions for proper collection, labeling, storage, and transport of expressed human milk; daily monitoring of maternal milk volume, creamatocrit measures, and number of times the breast pump is used; mother's use, dosing, and duration of prescription and non-prescription galactagogues; daily monitoring of an infant's total intake of human milk volume and non-human milk volume; documentation of attendance at Mothers' Milk Club meetings; documentation of assistance with at-breast feeding, including volume of milk consumed by an infant; preparation for feeding at breast and continued milk expression during a post-discharge period; and documentation of interactions with a mother; documentation of interactions with other health care providers.

17. A data management system for recording and monitoring lactation data, comprising:
a computer system comprising
a server having a computer readable program code,
an application module, and
a database module configured to contain one or more bits of information;
a user interface remote from the computer system; and
a communications link connecting the computer system and the user interface,
wherein the data management system is configured for simultaneous operation by one or more users, and wherein the data management system is configured to allow the one or more users to remotely access the application module of the computer system through the user interface thereby allowing the one or more users to input and retrieve the patient data in real time, and
wherein the computer readable program code is configured to be executed to implement a method for managing and documenting lactation data, the method comprising the steps of
prompting the one or users for login information and to receive the login information from the one or more users,
providing a user interface configured to allow input, editing, viewing, organizing and retrieval of patient data in real time by one or more users,
prompting the one or more users for patient data,
receiving patient data input from the one or more users,
communicating the patient data to a database,
storing the patient data in the database, and
wherein the data management system is configured to generate documents from the information contained in the database module.

18. The data management system of claim 17 wherein the computer readable program code is configured to be executed to prompt the one or more users for patient data comprising one or more personal information attributes selected from the group consisting of: first name, last name, hospital, maternal medical record, race, parity, birth date, home address, state, postal code, home telephone number, cellular telephone number, alternative telephone number, email address, education level, eligibility for government assistance, registration status for government assistance, total number of adults living in household, total number of children living in household, household income amount, occupation, date of return to work, gravida, para, T, and P.

19. The data management system of claim 18 wherein the readable program code is configured to be executed to prompt the one or users for patient data comprising one or more lactation events associated with a particular patient, the one or more lactation events selected from the group consisting of: initial lactation risk assessment; selection and instructions for use of an electric breast pump; correctly fitting breast pump equipment to an individual; review of lactogenesis, maternal medications, and dietary considerations with respect to producing an adequate volume of milk; instructions for use of a maternal milk volume record; instructions for proper collection, labeling, storage, and transport of expressed human milk; daily monitoring of maternal milk volume, creamatocrit measures, and number of times the breast pump is used; mother's use, dosing, and duration of prescription and non-prescription galactagogues; daily monitoring of an infant's total intake of human milk volume and non-human milk volume; documentation of attendance at Mothers' Milk Club meetings; documentation of assistance with at-breast feeding, including volume of milk consumed by an infant; preparation for feeding at breast and continued milk expression during a post-discharge period; and documentation of interactions with a mother; documentation of interactions with other health care providers.
